(19) United States
(12) Patent Application Publication
(10) Pub. No.: US 2003/0066411 A1
(43) Pub. Date: Apr. 10, 2003

(54) Choral teaching method and system

(76) Inventor: Douglas A. Holmberg, Lithia, FL (US)

Correspondence Address: Arthur W. Fisher, III, Suite 316, 5553 West Waters Avenue, Tampa, FL, 33634, US

(21) Appl. No.: 09/972,352

(22) Filed: Oct. 5, 2001

(51) Int. Cl. G10G 3/00

(52) U.S. Cl. 84/461

(57) ABSTRACT

A choral teaching method and system for teaching a singer to harmonize a particular harmonic part to a song comprising selecting the harmonic part to be learned, recording the particular harmonic part of the song, recording all four harmonic parts of the song, recording the song without the harmonic part to be learned, listening to the full harmonic recording to learn the sound of the selected harmonic part in harmony with the other three harmonic parts, listening to the particular harmonic part of the recording to learn the sound of the particular harmonic part and playing the recording without the harmonic part to be learned and singing the particular harmonic part with the other three harmonic parts.

### BACKGROUND OF THE INVENTION

1. Field of the Invention

A choral teaching method and system to teach a singer to harmonize.

2. Description of the Prior Art

Music learning devices have been available for years.

For example, recordings may include a musical rendition of an ensemble without a particular instrument to allow an individual to play that particular instrument along with the phonograph.

Another example comprises an audio teaching system for use in choral instruction wherein a four-channel cassett recorder/player is utilized in conjunction with specially prepared tapes having the four harmonic parts, soprano, alto, tenor and bass, recorded on separate channels whereby the choir practices the music selection with each member monitoring the appropriate harmonic part.

U.S. Pat. No. 2,123,258 describes a choral instructional system two interconnected turntables to play specially produced records, each containing two parts of a four-part harmony. Each of the records is used to feed audio to two sections of a choir with low pass and high pass filters employed to increase the loudness of the appropriate harmonic part with such filtered outputs feeding the entire pertaining section of the choir.

U.S. Pat. No. 3,955,466 teaches a performance learning system for a musical score, a play or vocal performance. An ensemble rendition of a program is recorded on a first track with a particular performance, which normally is a part of the program being omitted from the prerecorded ensemble rendition. A student may record a performance on a third track of the tape while an exemplary performance of the omitted performance such as may be formed by a professional or teacher is recorded on a fourth track.

U.S. Pat. No. 4,732,072 discloses an audio teaching system for use in choral instruction having a four-track cassette recorder/player interconnected with a four-channel amplifier leading to a set of earphone amplifier control boxes, each having a single earphone attached thereto. The four harmonic parts of the music selection are recorded on separate channels. A selector switch allows the choir member to choose to monitor one or all of the harmonic parts.

French 2,623,931 describes an apparatus in association with a cassette recorder and stereo system an amateur singer can use to train to sing with pre-recorded orchestral accompaniment. For this purpose he uses a cassette on which are recorded on a first track the musical accompaniment and on a second track a vocal guide consisting of the performance of a professional singer. While singing in front of the microphone he can adjust the listening levels on two speakers of the stereo system of the musical accompaniment and of the vocal guide independently with the aid of slide potentiometers. He can thus gradually suppress the vocal guide in accordance with his own progress.

European Patent 475,758 relates to a recording of a musical performance reproduced from a video tape or disk. One audio track carries the solo part of the music. A different track carries the accompaniment orchestra or piano. The sound tracks are reproduced together for listening, or only one track is reproduced to enable a person to participate as a soloist or accompanist.

Great Britain 2,153,131 shows a music laboratory having a number of pupil stations with an electronic keyboard and a set of headphones and a central instructor station where the playing of individual parts can be listened to and recorded and from which live instructions and recorded material can be passed to the pupils.

### SUMMARY OF THE INVENTION

The present invention relates to a method and system for teaching a singer to harmonize one of the harmonic parts to a song including an audio recording for teaching each of the four harmonic parts separately.

For example, all four harmonic parts are recorded together on a medium such as a record, tape, disk or other suitable media. The harmonic part to be learned is recorded separately on the medium. The remaining three or accompanying harmonic parts are recorded on the medium. Thus, the audio recording comprises separate tracks of the particular harmonic part to be learned, all the harmonic parts including the particular harmonic part to be learned and all the harmonic parts without the particular harmonic part to be learned.

Once the various tracks are recorded, the singer is able to selectively listen to the various tracks to learn his or her particular harmonic part on a recording player such as a cassette/disk player. The singer inserts a prerecorded tape, prerecorded compact disk or other medium of the teaching recording with the appropriate or particular harmonic part into the cassette receptacle or compact disk receptacle. Controls for the cassette section and disk section of the cassette/disk player including a volume control and a balance control.

Regardless of the recording medium, cassette tape, compact disk or other, the singer is able to alternately and randomly select the single particular harmonic part to be learned, all the harmonic parts including the particular harmonic part to be learned and all the harmonic parts without the particular harmonic part to be learned.

When the recorded media is played the student tunes the speaker control to listen only the part to be learned. When the speaker control is in the central or balanced position all of the harmonic parts are heard, to demonstrate to the student how his or her part sounds in combination with the rest of the harmony. When the speaker control is tuned all the way in the opposite direction, the three harmonic parts minus the part being learned are heard. This last position would provide the student with the opportunity to sing the learned harmony.

The invention accordingly comprises the features of construction, combination of elements, and arrangement of parts that will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is an audio player configured to alternately play selected tracks of a sound recording of the present invention.

Similar reference characters refer to similar parts throughout the several views of the drawings.

### DETAILED DESCRIPTION OF THE PREFERRED EMBODIMENT

The present invention relates to a method and system for teaching a singer to harmonize one of the harmonic parts to a song. The method and system envisions providing separate recordings to teach each of the four harmonic parts including soprano, alto, tenor and bass.

The method and system includes an audio recording for teaching each of the four harmonic parts separately. For example, all four harmonic parts are recorded on a medium such as a record, tape, disk or other suitable media. The harmonic part to be learned is recorded separately on the medium. The remaining or accompanying harmonic parts are recorded on the medium. Thus, the audio recording of a particular song having a harmonic part to be learned comprises separate tracks of the particular harmonic part to be learned, all the harmonic parts including the particular harmonic part to be learned and all the harmonic parts without the particular harmonic part to be learned. So configured, audio recordings for each of the four harmonic parts may be produced to selectively teach any of the harmonic parts as depicted in Table 1 below.

TABLE 1

| Harmonic | Recorded | Recorded | Recorded |
|---|---|---|---|
| Part (designation) | Track 1 | Track 2 | Track 3 |
| Soprano (1) | 1 | 1,2,3,4 | 2,3,4 |
| Alto (2) | 2 | 1,2,3,4, | 1,3,4 |
| Tenor (3) | 3 | 1,2,3,4 | 1,2,4 |
| Bass (4) | 4 | 1,2,3,4 | 1,2,3 |

As described, the method and system of the present invention may comprise a single recording for teaching and learning the particular harmonic part or a plurality of recordings for teaching and learning two or more of the harmonic parts.

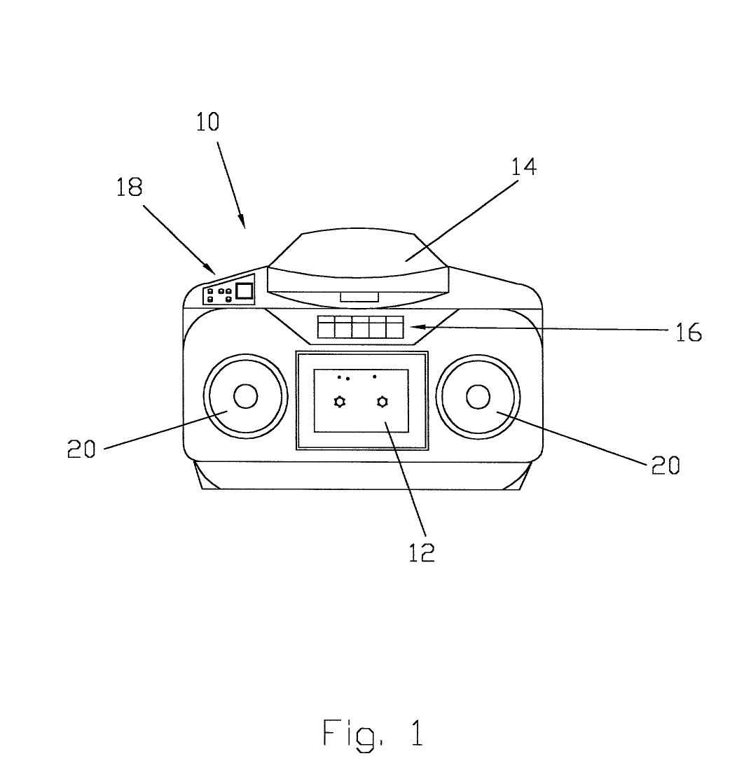

Once the various tracks are recorded, the singer is able to selectively listen to the various tracks to learn his or her particular harmonic part on a recording player such as a cassette/disk player generally shown as 10 in FIG. 1. For example, the singer inserts a prerecorded tape or a prerecorded compact disk of the teaching recording with the appropriate or particular harmonic part to be learned into the cassette receptacle 12 or compact disk receptacle 14 respectively. Controls for the cassette section and disk section of the cassette/disk player 10 including a volume control and a balance control are generally indicated as 16 and 18 respectively.

Regardless of the recording medium, cassette tape, compact disk or other, the singer is able to alternately and randomly select the single particular harmonic part to be learned, all the harmonic parts including the particular harmonic part to be learned and all the harmonic parts without the particular harmonic part to be learned.

When the recorded media is played the student tunes the speaker control all the way to the left (or right) to hear only the part to be learned. When the speaker control is in the central or balanced position all of the harmonic parts are heard thereby demonstrating to the student how his part sounds in combination with the rest of the harmony. When the speaker control is tuned all the way in the opposite direction, the three harmonic parts minus the part being learned are heard through the speakers each indicated as 20. This last position would provide the student with the opportunity to sing the learned harmony.

In particular, one or more of the harmonic parts with corresponding partial harmonization, other three harmonic parts, and all four harmonic parts may be recorded on a single medium. Table 1 illustrates each of the four harmonic parts with the respective combination of harmonizing parts for each track.

In use, a person wishing to learn to harmonize as a soprano would select Track 1 for the soprano to hear the soprano's part (1) alone and practice the soprano part (1), select Track 2 to hear and practice with all four harmonic parts (1, 2, 3, 4) including soprano and select Track 3 without the soprano part (1) but with the remaining three harmonic parts (2, 3, 4) to sing along in harmony as the soprano.

A person wishing to learn to harmonize as an alto would select Track 1 for the alto to hear the alto's part (2) alone and practice the alto part (2), select Track 2 to hear and practice with all four harmonic parts (1, 2, 3, 4) including alto and select Track 3 without the alto part (2) but with the remaining three harmonic parts (1, 3, 4) to sing along in harmony as the alto.

A person wishing to learn to harmonize as a tenor would select Track 1 for the tenor to hear the tenor part (3) alone and practice the tenor part (3), select Track 2 to hear and practice with all four harmonic parts (1, 2, 3, 4) including tenor and select Track 3 for without the tenor part (3) but with the remaining three harmonic parts (1, 2, 4) to sing along in harmony as the tenor.

A person wishing to learn to harmonize as a bass would select Track 1 for the bass to hear the bass part (4) alone and practice the bass part (4), select Track 2 to hear and practice with all four harmonic parts (1, 2, 3, 4) including bass and select Track 3 for without the bass part (4) but with the remaining three harmonic parts (1, 2, 3) to sing along in harmony as the bass.

As described, one or more of the three tracks for each single harmonic part (1, 2, 3, 4) may be recorded singly on a medium allowing a recording to be used for more than one harmonic part (1, 2, 3, 4).

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

What is claimed is:

1. A choral teaching method for teaching a singer to harmonize a particular harmonic part to a song comprising selecting the harmonic part to be learned, recording the particular harmonic part of the song to be learned, recording all four harmonic parts of the song, recording the song without the harmonic part to be learned, listening to the full harmonic recording including all four harmonic parts to learn the sound of the selected harmonic part in harmony with the other three harmonic parts, listening to the particular harmonic part of the recording to learn the sound of the particular harmonic part and playing the recording without the harmonic part to be learned and singing the particular harmonic part with the other three harmonic parts.

2. A choral teaching method of claim 1 for teaching all four harmonic parts of the song comprising recording all four harmonic parts separately and separately recording the other three harmonic parts for each harmonic part to be learned separately recorded, listening to the full harmonic recording including all four harmonic parts to learn the sound of the selected harmonic part in harmony with the other three harmonic parts, listening to the particular harmonic part of the recording to learn the sound of the particular harmonic part and playing the recording without the harmonic part to be learned and singing the particular harmonic part with the other three harmonic parts.

3. A choral teaching system for teaching a singer to harmonize a particular harmonic part to a song comprising a device to record or play the harmonic part to be learned selecting the harmonic part to be learned, recording the particular harmonic part of the song, all four harmonic parts of the song and the song without the harmonic part to be learned, playing to the full harmonic recording to learn the sound of the selected harmonic part in harmony with the other three harmonic parts, the particular harmonic part of the recording to learn the sound of the particular harmonic part and the recording without the harmonic part to be learned.

4. A choral teaching system of claim 3 for teaching all four harmonic parts of the song comprising a device to record and play all four harmonic parts separately and separately recording the other three harmonic parts for each harmonic part to be learned separately recorded, playing to the full harmonic recording to learn the sound of the selected harmonic part in harmony with the other three harmonic parts, the particular harmonic part of the recording to learn the sound of the particular harmonic part and recording without the harmonic part to be learned.
